(19) United States
(12) Patent Application Publication
(10) Pub. No.: US 2006/0086224 A1
(43) Pub. Date: Apr. 27, 2006

(54) Dual-purpose shredder

(76) Inventor: Emily Lo, Hsin Chuang City (TW)

Correspondence Address: PRO-TECHTOR INTERNATIONAL, 20775 Norada Court, Saratoga, CA, 95070-3018, US

(21) Appl. No.: 10/891,328

(22) Filed: Jul. 14, 2004

(51) Int. Cl. B26D 5/08

(52) U.S. Cl. 83/523

(57) ABSTRACT

The present invention relates to a dual-purpose shredder, and the purpose of which is to add an extra blade unit in parallel with the two blade units of a conventional type to form a CD slot, in addition to a paper slot, thereby enabling the shredder shredding papers when a motor rotating clockwise and crushing CDs when the motor rotating counter-clockwise.

### BACKGROUND OF THE INVENTION

(a) Field of the Invention

The present invention relates to a shredder with three blade units, wherein the first and second blade units form a paper slot for shredding papers and the second and third blade units form a CD slot for crushing CD.

(b) Description of the Prior Art

A conventional dual-purpose shredder includes two blade units forming a paper slot for shredding papers and a CD slot overlapping thereon for crushing CD, thereby, with the same blade units for different purposes, damage to blade units can be easily happened, which shortening shredder's service life.

### SUMMARY OF THE INVENTION

The purpose of the present invention is to form a CD slot by adding an extra blade unit in parallel with the two blade units of a conventional shredder, wherein the middle blade unit works in conjunction with either the right blade unit or left blade, thereby enabling the shredder shredding papers when a motor rotating clockwise and crushing CD when the motor rotating counter-clockwise.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention.

FIG. 2 shows a side view of a reduction gear set of the present invention.

FIG. 3 shows a side view of the present invention.

FIG. 4 shows another side view of the reduction gear set of the present invention.

FIG. 5 shows another side view of the present invention.

### DETAILED DESCRIPTION OF THE PREFERRED EMBODIMENTS

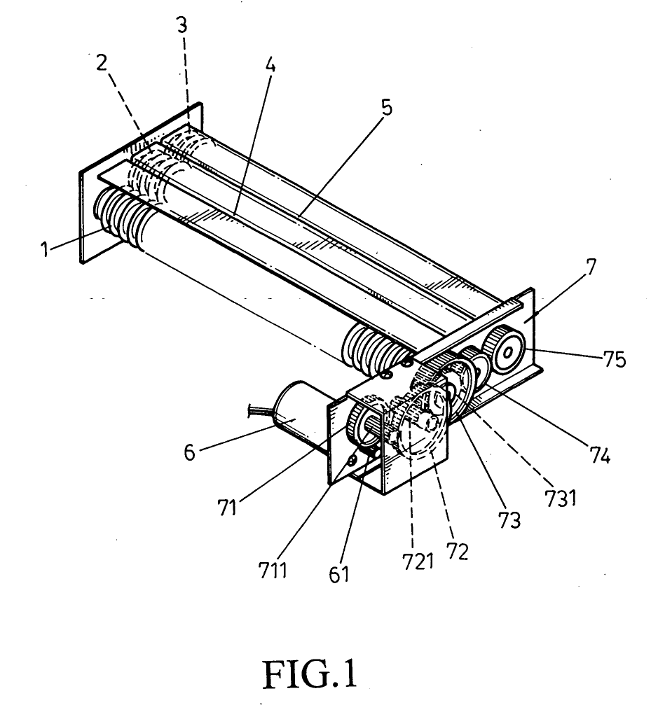

Referring to FIG. 1. The present invention includes three sets of blade units 1, 2, and 3, a motor 6, and a reduction gear set 7, wherein, a paper slot 4 formed between blade units 1 and 2, a CD slot 5 formed between blade units 2 and 3, the motor 6 rotates to drive blades units 1, 2, and 3 through the reduction gear set 7. Referring to FIG. 3. A shaft 61 of the motor 6 is formed to drive a gear 71, which triggers chain rotations from a gear 72 through a shaft 711, to a gear 73 through a shaft 721, and to a gear 74 through a shaft 731, and finally to a gear 75, wherein gears 73, 74, and 75 connects blade units 1, 2, and 3, respectively, thereby enabling blade units 1, 2, and 3 rotating accordingly when gears 73, 74, and 75 rotating.

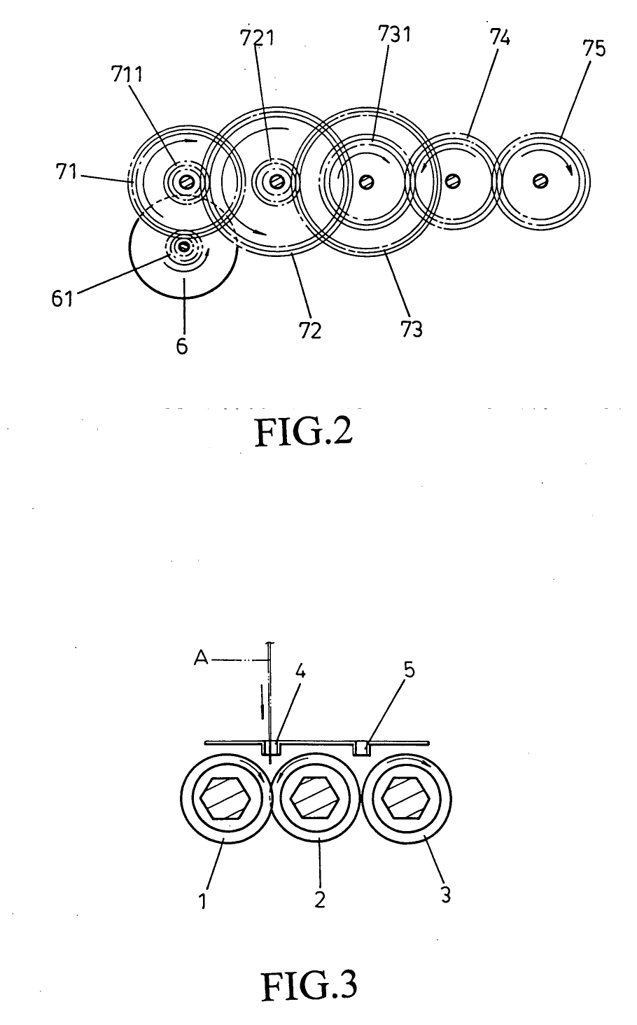

Referring to FIGS. 2 and 3. Inserting papers A through the paper slot 4 to a space between blade units 1 and 2, papers A will be brought downwards and shredded when turning on the motor 6, whereas the CD slot 5 can't work due to outwards rotations between blade units 2 and 3.

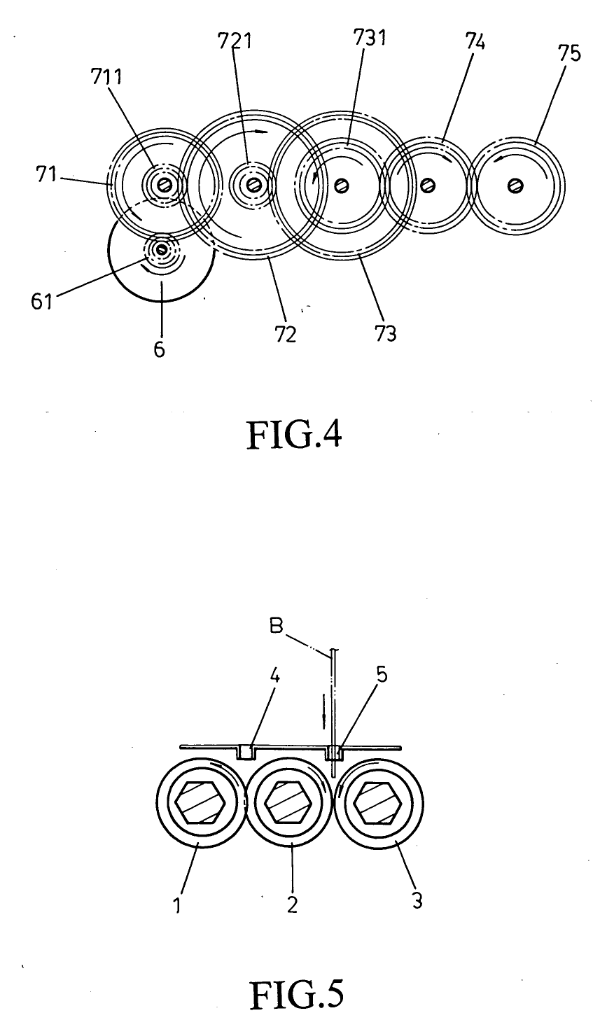

Referring to FIGS. 4 and 5. Inserting a CD B through the CD slot 5 to a space between blade units 2 and 3, the CD B will be brought downwards and crushed when turning on the motor 6, whereas the paper slot 4 can't work due to outwards rotations between blade units 1 and 2.

In summary, the present invention utilizes three blade units to form a paper slot for shredding papers and a CD slot for crushing CDs.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A dual purpose shredder comprising a motor, a reduction gear set, and three blade units, wherein, an additional blade unit formed in parallel with the two blade units of a conventional shredder, a paper slot formed on the first and second blade units for shredding papers, a CD slot formed on the second and third blade units for crushing CDs, and the motor connecting to the reduction gear set, which gearing with blade units, thereby enabling the motor to drive the reduction gear set and further to blade units.

2. The dual-purpose shredder as recited in claim 1, wherein an additional reduction gear formed to drive the additional blade unit.
